(19) United States
(12) Patent Application Publication
(10) Pub. No.: US 2008/0006512 A1
(43) Pub. Date: Jan. 10, 2008

(54) Wireless remote auger control

(75) Inventor: Timothy L. Kuhus, Arcola, IL (US)

Correspondence Address: Tim Kuhus, P.O. Box 168, Arthur, IL, 61911, US

(73) Assignee: E - Z Trail, Inc., Arthur, IL (US)

(21) Appl. No.: 11/089,832

(22) Filed: Mar. 24, 2005

(51) Int. Cl. B65G 33/00

(52) U.S. Cl. 198/670

(57) ABSTRACT

A wireless remote control for a hydraulically powered auger. A hydraulic bypass valve is moved by an electrically powered linear actuator, which is activated by a DC polarity reversing receiver, which operates when a signal is received from a remote transmitter, allowing the operator to turn the auger on and off from anywhere in the vicinity of the machine.

### FIELD OF THE INVENTION

The present invention relates to controlling an hydraulic auger and, more particularly, to a means to turn the auger on and off with a wireless remote control.

### BACKGROUND OF THE INVENTION

Tubes having powered augers or conveyor belts therein have been widely employed in the past to convey particulates such as seed or fertilizer from a container such as a gravity wagon or a truck box to seed and fertilizer hoppers on planters or grain drills. With the advent of wider planters, for example of up to 60 feet in width for planting up to 24 rows at the same time, telescoping discharge spouts have been utilized to maximize the reach at which the seed may be discharged from the auger to service the planter in order to minimize the number of times that the gravity wagon or truck has to be moved before replenishment of the hoppers is complete. When moving the discharge spout between the respective planter seed hoppers, the auger drive motor is usually stopped to prevent loss of seed, and is then restarted when the spout has been repositioned. When the operator is at the end of the telescoping spout, there is a need for a way control the motor from a distance.

In the past, control of the drive motor which typically is hydraulic, has been accomplished by bypassing the hydraulic fluid thru a manually operated valve in order to stop the hydraulic motor, the valve can be operated by a rod running to the discharge end of the auger, and/or by one or more ropes going to the end of the discharge spout. Another means used in the past of controlling the motor is with an electrically activated hydraulic solenoid bypass valve controlled by a switch at the end of the telescoping spout as in U.S. Pat. No. 5,746,303.

The difficulty with a manually operated valve is that the discharge end of the telescoping spout may be quite remote from the motor and valve. Ropes have been used to control the valve from the discharge end of the spout. However, a rope that is long enough to reach the end of the spout when it is extended to it's longest position, will have considerable excess length when the spout is in a shorter position. This excess length can easily become entangled and is a possible safety hazard.

Numerous difficulties have been encountered with an electrically activated hydraulic solenoid bypass valve. The solenoid valve can cause enough of a restriction in the hydraulic flow in its normally open state to keep the motor from coming to a complete stop. When the solenoid valve is closed it does not always completely stop the flow of hydraulic fluid which reduces the power of the hydraulic motor. The manual bypass valve can be used, in conjunction with a solenoid bypass valve, to stop to motor. However, in the event of the solenoid valve or the switch or the electric power supply to the solenoid valve malfunctioning, the only way to make the motor run with the manual bypass valve is to completely remove the solenoid valve which requires disassembling the hydraulic connections and reassembling them, a messy and time consuming task. Another limitation is that the solenoid valve can only be operated from within reach of the switch. Another shortcoming is that the solenoid valve needs to draw continuous electrical power to stay open for the entire time that the motor is operating.

It is therefore an object of the invention to provide a way to start and stop a hydraulically powered auger with a wireless remote control.

It is another object of the invention to use the existing manual hydraulic bypass valve to start and stop the auger.

It is another object of the invention to easily convert the auger back to being controlled manually.

### SUMMARY OF THE INVENTION

In accordance with the present invention, there is provided a wireless remote control for a hydraulically powered auger. The manual hydraulic bypass valve is moved by an electrically powered linear actuator, which is activated by a DC polarity reversing radio frequency receiver, which is controlled by a remote transmitter, allowing the operator to turn the auger on and off from anywhere in the vicinity of the machine.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a hydraulic auger with a telescoping spout and a wireless remote control installed.

For purposes of clarity and brevity, like elements and components will bear the same designations and numbering throughout the FIGURES.

### DESCRIPTION OF THE PREFERRED EMBODIMENT

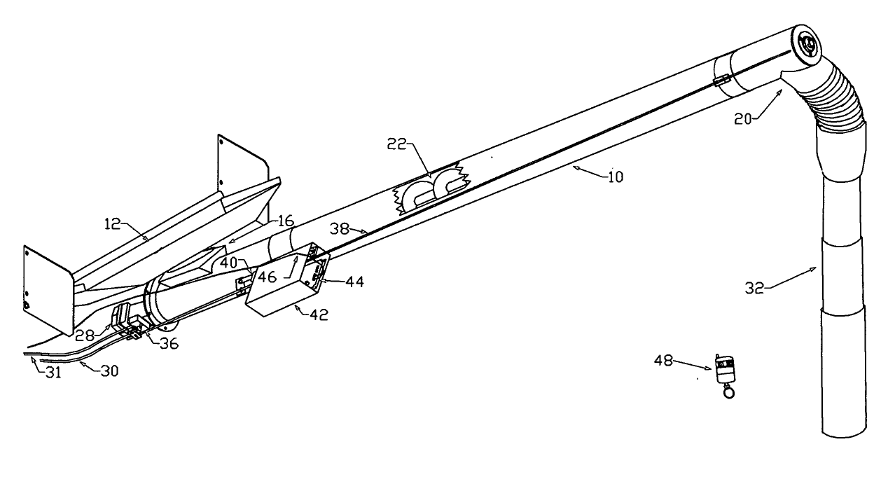

FIG. 1 shows a hydraulic auger unit with a telescoping spout 32 and a wireless remote control installed. Although the present invention is hereafter described as used with a hydraulic auger, it would will work equally well with a hydraulic belt conveyor. The auger unit consists of a hopper 12 will attaches to the container, (not shown) such as a gravity wagon or truck box which contains the particulate material, such as seed or fertilizer, to be conveyed by the auger. The tube 10 is mounted, preferably in a manner which will allow pivotal movement, to the hopper 12. Thus the auger tube 10 may be swivelable relative to the material supply container. The lower end of the tube 10 contains an inlet 16 whereby the particulate material may enter the tube 10 to be conveyed by the auger screw 22 to the opposite end of the tube 10 and exit thru the discharge 20. A spout 32 is typically fastened to the discharge 20 to direct the flow of the material. An auger screw 22, extends longitudinally for substantially the length of and inside of the the tube 10. The auger screw 22 is rotated by a fluid powered motor 28, preferably a hydraulic motor 28, which may be mounted at either end, but preferably at the inlet 16 end of the tube 10. The motor 28 receives pressurized fluid from a power source thru a supply conduit 30 and returns fluid to the power source thru a return conduit 31. The bypass valve 36 may be connected between the supply and return conduits with T-fittings, or preferably mounted directly on the motor 28 with the supply and return conduits attaching to the bypass valve 36. A rod 38 attaches to the bypass valve 36 and extends substantially the entire length of the tube 10.

The wireless remote control consists of a linear actuator 40 and a receiver 44 mounted to the tube 10 with a bracket 42. The bracket 42 could be mounted anywhere along the tube 10, but keeping it near the intake reduces the weight on the discharge 20 end and shortens the length of conductor 46 required.

The moving end of the linear actuator 40 is fastened to the rod 38. A conductor 46 supplies electrical power, preferably 12 volt DC, to the receiver 44 from a power source such as the towing vehicle's electrical system, or a battery. The transmitter 48 is powered by it's own battery and used by the operator to send a signal to the receiver 44. While the preferred method of transmitting a signal is with radio frequencies, other types of transmitters such as infrared based systems may be used.

In operation, the operator would typically first start the flow of pressurized fluid from the power source, then move the auger and spout 32 to the desired position and then start the motor 28 by changing the position of the bypass valve 36. The bypass valve 36 has two positions, the open position will allow fluid to flow from the supply conduit 30 thru the bypass valve 36 and back to the power source thru the return conduit 31, thus bypassing the motor 28 and leaving it stopped. When the bypass valve 36 is moved to the closed position, the pressurized fluid is forced to pass thru the motor 28, thus causing it to rotate. The rod 38 connects to the bypass valve 36 which allows the operator to open and close the bypass valve 36 from anywhere along the length of the tube 10. When moving the spout 32 between the respective planter hoppers, the motor 28 is usually stopped to prevent loss of seed or fertilizer, and is then restarted when the spout 32 has been repositioned. In the past, it was common to use a flexible spout 32 of relatively short length, for example 4 feet, thus the operator was able to direct the flow of material coming out of the end of the spout 32 and still be close enough to the discharge 20 to reach the top end of the rod 38 and turn the auger on and off by pushing or pulling on the rod 38. With the advent of wider planters, for example of up to 60 feet in width for planting up to 24 rows at the same time, telescoping spouts have been utilized to maximize the width at which the seed may be discharged from the auger in order to minimize the number of times that the truck or gravity wagon has to be moved before replenishment of the planter is complete. A telescoping spout 32 typically has a short piece of flexible spouting which attaches to the discharge 20 allowing the spout 32 to be adjusted to any number of differing angles and directions relative to the tube 10. The telescoping spout 32 can be slid out to considerable length, for example up to 17 feet. When the operator is at the end of the telescoping spout 32 directing the flow of material, he will generally be too far from the tube 10 to reach the rod 38 to turn the auger on and off manually.

The present invention provides a way for the operator to start and stop the auger from anywhere in the vicinity of the auger regardless of his distance from the bypass valve 36, the rod 38, or the spout 32. The transmitter 48 has two buttons. The operator pushes one button to send a signal to the receiver 44 which then sends electric current to the linear actuator 40 causing it to retract which pulls on the rod 38, which closes the bypass valve 36 starting the motor 28 and conveying the material. When the operator desires to stop the auger, he pushes the opposite button on the transmitter 48, which sends a signal to the receiver 44, which sends electric current to the linear actuator 40 with the opposite polarity, positive and negative charges reversed, causing it to extend, pushing on the rod 38 which opens the bypass valve 36 and stops the motor 28.

Should there ever be a malfunction of any of the remote control components, or a loss of electrical power, all that is required to convert the auger back to manual control is removing the one bolt that attaches the linear actuator 40 to the rod 38.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A wireless remote auger control for starting and stopping a hydraulic auger comprising:
means for bypassing hydraulic fluid around the motor to stop the rotation of the auger;
means for changing the position of the bypass valve, fastened to said means for bypassing hydraulic fluid around the motor to stop the rotation of the auger;
means for adjusting the position of the bypass valve using electrical power, removably fastened to said means for changing the position of the bypass valve;
means for mounting the linear acctuator and the receiver to the tube, attached to said means for adjusting the position of the bypass valve using electrical power;
means for sending an electric current when a signal is received, attached to said means for mounting the linear acctuator and the receiver to the tube, and electrically connected to said means for adjusting the position of the bypass valve using electrical power; and
means for sending a signal to the receiver.

2. The wireless remote auger control in accordance with claim 1, wherein said means for bypassing hydraulic fluid around the motor to stop the rotation of the auger comprises a manually operated bypass valve.

3. The wireless remote auger control in accordance with claim 1, wherein said means for changing the position of the bypass valve comprises a rod.

4. The wireless remote auger control in accordance with claim 1, wherein said means for adjusting the position of the bypass valve using electrical power comprises a linear actuator.

5. The wireless remote auger control in accordance with claim 1, wherein said means for mounting the linear acctuator and the receiver to the tube comprises a bracket.

6. The wireless remote auger control in accordance with claim 1, wherein said means for sending an electric current when a signal is received comprises a receiver.

7. The wireless remote auger control in accordance with claim 1, wherein said means for sending a signal to the receiver comprises a transmitter.

8. A wireless remote auger control for starting and stopping a hydraulic auger comprising:
a manually operated bypass valve, for bypassing hydraulic fluid around the motor to stop the rotation of the auger;
a rod, for changing the position of the bypass valve, fastened to said bypass valve;
a linear actuator, for adjusting the position of the bypass valve using electrical power, removably fastened to said rod;
a bracket, for mounting the linear acctuator and the receiver to the tube, attached to said linear actuator;
a receiver, for sending an electric current when a signal is received, attached to said bracket, and electrically connected to said linear actuator; and
a transmitter, for sending a signal to the receiver.

9. The wireless remote auger control as recited in claim 8, further comprising:
a hydraulic motor, for rotating the auger, rigidly mounted to said bypass valve.

10. A wireless remote auger control for starting and stopping a hydraulic auger comprising:
a hydraulic motor, for rotating the auger;
a manually operated bypass valve, for bypassing hydraulic fluid around the motor to stop the rotation of the auger, rigidly mounted to said motor;
a rod, for changing the position of the bypass valve, fastened to said bypass valve;
a linear actuator, for adjusting the position of the bypass valve using electrical power, removably fastened to said rod;
a bracket, for mounting the linear acctuator and the receiver to the tube, attached to said linear actuator;
a receiver, for sending an electric current when a signal is received, attached to said bracket, and electrically connected to said linear actuator; and
a transmitter, for sending a signal to the receiver.
